(19) United States
(12) Patent Application Publication
(10) Pub. No.: US 2007/0243736 A1
(43) Pub. Date: Oct. 18, 2007

(54) Memory Card Connector with Card Over-Running Protection

(76) Inventor: Shinichiro Maruyama, Kanagawa (JP)

Correspondence Address: Charles S. Cohen;MOLEX INCORPORATED, 2222 Wellington Court, Lisle, IL, 60532, US

(21) Appl. No.: 10/587,319

(22) PCT Filed: Jan. 24, 2005
(86) PCT No.: PCT/US05/02155

§ 371 Date: Jun. 8, 2007

(30) Foreign Application Priority Data
Jan. 26, 2004 (JP) 2004-016978

(51) Int. Cl. H01R 13/62

(52) U.S. Cl. 439/159

(57) ABSTRACT

A memory card connector (34) includes an insulative housing (36) having a terminalmounting section (36a) which mounts a plurality of conductive terminals (44) having contact portions (44a) for engaging appropriate contacts on a memory card (60). The housing at least in part defines a card-receiving cavity (40) for receiving the memory card. A card eject mechanism (46) includes a slider (50) movably mounted on the housing. The slider is engageable with the memory card for movement therewith into and out of the cavity between an inserted connection position and a withdrawal position. The card eject mechanism includes an ejection spring (56) to bias the slider and memory card in an ejection direction toward the withdrawal position. A catch means (70) is provided for catching the memory card in its movement in the ejection direction and preventing the memory card from moving under inertia beyond the withdrawal position.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card, itself, writes or reads via the connector and can transmit between electrical appliances, such as a word processor, personal computer, personal data assistant or the like. The card may be used in applications such as mobile or cellular telephones which are actuated and permit data access after identifying an identification code stored on a SIM (subscriber identification module) card. The SIM card has a conductive face with an array of contacts, and the mobile phone has a SIM card connector with terminals for electrical connection with the contacts of the SIM card to ensure the subscriber identification confirmation.

A typical memory card connector includes some form of dielectric housing, which is covered by a metal shell. The metal shell may be stamped and formed of sheet metal material and formed substantially into a box-shape. The metal shell and the housing combine to define a card-receiving cavity. One end of the cavity is open to form a card-insertion opening. The dielectric housing may be generally L-shaped or U-shaped and includes a rear terminal-mounting section at the rear of the cavity, and at least one longitudinal side wall section extends forwardly from one or both ends of the rear section at one or both sides of the cavity. The metal shell has a top plate substantially covering the dielectric housing, with side plates extending downwardly over the side wall sections of the housing. One or both of the side wall sections of the housing define the sides of the card-receiving cavity.

Some card connectors include a card eject mechanism whereby the memory card is simply inserted into the connector, and the eject mechanism is used to facilitate removal of the card from the connector. Some eject mechanisms include slider members which engage the memory card for movement therewith into and out of the connector. Latches, cams, eject devices and other operative components then are operatively associated with the slider rather than the memory card itself. One type of card eject mechanism includes a heart-shaped cam slot in the slider, with a pin member operatively biased into the heart-shaped cam slot, and with a spring member to normally bias the slider in a direction of withdrawal of the memory card. This type of card eject mechanism is called a “push/push type” ejector in that the memory card first is pushed into the cavity of the connector to a latched operative position, and a second push on the card is effective to release the card and allow the spring to eject the card from its latched position. Such mechanisms are shown in prior art publications Japanese Patent Laid-Open Nos. 2002-252047 and 2002-319451.

The push/push type and other types of eject mechanisms which use spring members to eject the card from its latched position cause various problems. For instance, it is quite difficult to maintain a proper spring constant in the spring member. If the ejection spring is relatively weak, the ejection and removal of the memory card is difficult and unsatisfactory. On the contrary, if the ejection spring is too strong, the card and slide member are driven quickly in the ejection direction, and the memory card actually can jump out of the card connector and fall to the floor. The present invention is directed to solving these problems by providing an anti-over-running mechanism to prevent the memory card from coming out of the connector even when using an ejection spring which is strong enough to eject the card with a short, sharp movement.

### SUMMARY OF THE INVENTION

An object, therefore, of the invention is to provide a new and improved memory card connector of the character described.

In the exemplary embodiment of the invention, the memory card connector includes an insulative housing having a terminal-mounting section, which mounts a plurality of conductive terminals having contact portions for engaging appropriate contacts on a memory card. The housing at least in part defines a card-receiving cavity for receiving the memory card. A card eject mechanism includes a slider movably mounted on the housing. the slider is engageable with the memory card for movement therewith intoand out of the cavity between an inserted connection position and a withdrawal position. The card eject mechanism includes an ejection spring to bias the slider and memory card in an ejection direction toward the withdrawal position. A catch means is provided for catching the memory card in its movement in the ejection direction and preventing the memory card from moving under inertia beyond the withdrawal position.

According to one aspect of the invention, the cavity has a front insertion opening, and the catch means is located near the opening. The catch means comprises a catch member on the connector engageable with a recess in the memory card. As disclosed herein, the catch member comprises a cantilevered leaf spring.

According to another aspect of the invention, the terminal-mounting section of the housing is a rear section, and at least one side wall section of the housing extends forwardly from one end of the rear section. Both the card eject mechanism and the catch means are located on the side wall section of the housing.

According to a further aspect of the invention, a metal shell is mounted on the housing and combines therewith to define the cavity. The metal shell is stamped and formed from sheet metal material, and the catch means comprises a cantilevered leaf spring stamped and formed from the shell at one side thereof near the front insertion opening of the cavity.

Other objects, features and advantages of the invention will be apparent from the following detailed description taken in connection with the accompanying drawings.

### Brief Description of the Drawings

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a top plan view of a memory card connector according to the invention;

FIG. 2 is a side elevational view of the connector;

FIG. 3 is a front elevational view of the connector, looking at the opening to the card-receiving cavity;

FIG. 4 is a fragmented vertical section taken generally along line 4-4 in FIG. 1,

FIG. 5 is a fragmented top plan view of a front corner of the metal shell of the connector, showing a mechanism to prevent the memory card from over-running its withdrawal position;

FIG. 6 is a vertical section taken generally along line 6-6 in FIG. 5;

FIG. 7 is an enlarged, fragmented, exploded perspective view of the slider of the card eject mechanism along with a slide lock member and an ejection control member;

FIG. 8 is an enlarged perspective view of the slider, looking at the opposite side thereof in relation to FIG. 7, and in conjunction with a corner of a memory card;

FIG. 9 is a top plan view of the connector, with a memory card inserted thereinto and in its inserted connection position;

FIG. 10 is a perspective view showing the condition of the catch means for preventing over-running of the memory card, when the card is in its inserted connection position of FIG. 9;

FIGS. 11 and 12 are views similar to that of FIGS. 9 and 10, respectively, but showing the catch means catching the memory card and preventing over-running thereof; and

FIG. 13 is a view similar to that of FIG. 5, but of an alternative embodiment of the invention.

### DETAILED DESCRIPTION OF THE PREFERRED EMBODIMENTS

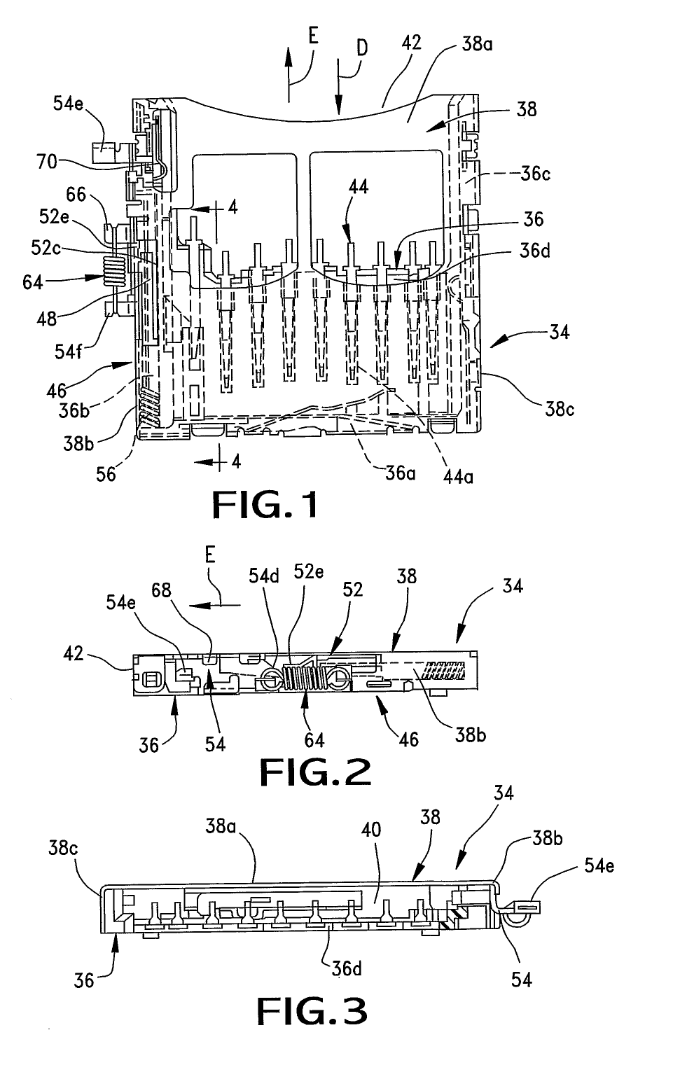

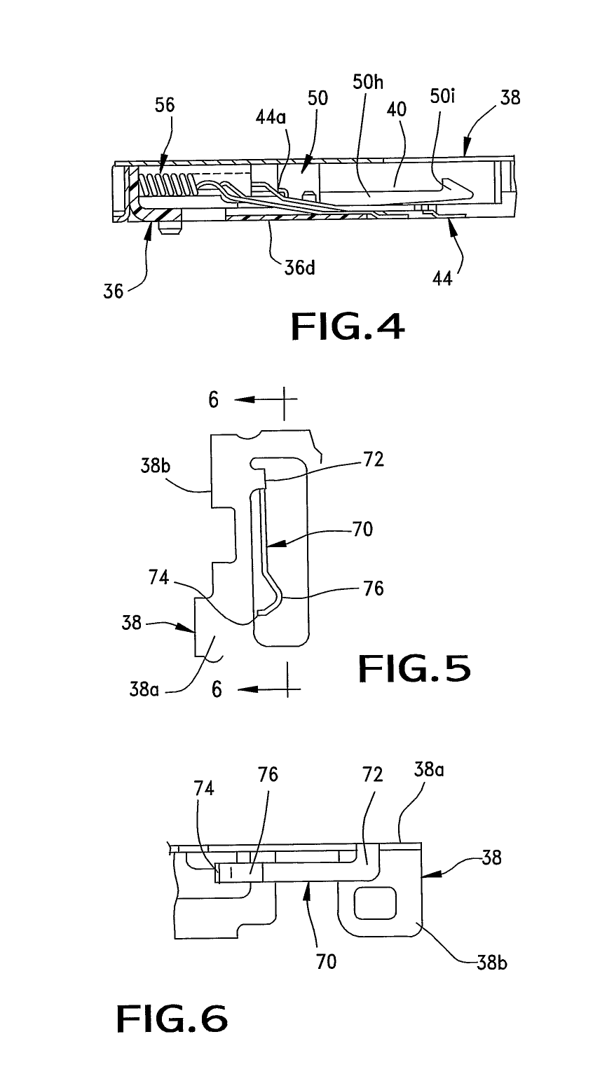

Referring to the drawings in greater detail, and first to FIGS. 1-4, the invention is embodied in a memory card connector, generally designated 34, which includes an insulative housing, generally designated 36, substantially covered by a stamped and formed metal shell, generally designated 38. The housing and the shell combine to form a card-receiving cavity 40 which has a front insertion opening 42 to permit insertion of a memory card into the cavity in the direction of arrow “D” (FIG. 1) and withdrawal of the memory card from the cavity into the direction of arrow “E”. Housing 36 may be molded of dielectric material such as plastic or the like, and metal shell 38 may be stamped and formed out of sheet metal material such as stainless steel or the like.

Insulative housing 36 of connector 34 is generally U-shaped and includes a rear terminal-mounting section 36a and a pair of side wall sections 36b and 36c extending forwardly from opposite ends of the rear section. The rear section includes an integral floor 36d (FIG. 3), which spans the side walls sections at the bottom of cavity 40.

A plurality of conductive terminals, generally designated 44, are mounted on the rear section of the housing on floor 36d. The terminals have contact portions 44a which project forwardly into cavity 40, above floor 36d, for engaging appropriate contacts on the memory card.

Metal shell 38 of connector 34 includes a top wall 38a and a pair of opposite longitudinal side walls 38b and 38c. The top wall of the metal shell, basically, forms the top of cavity 40.

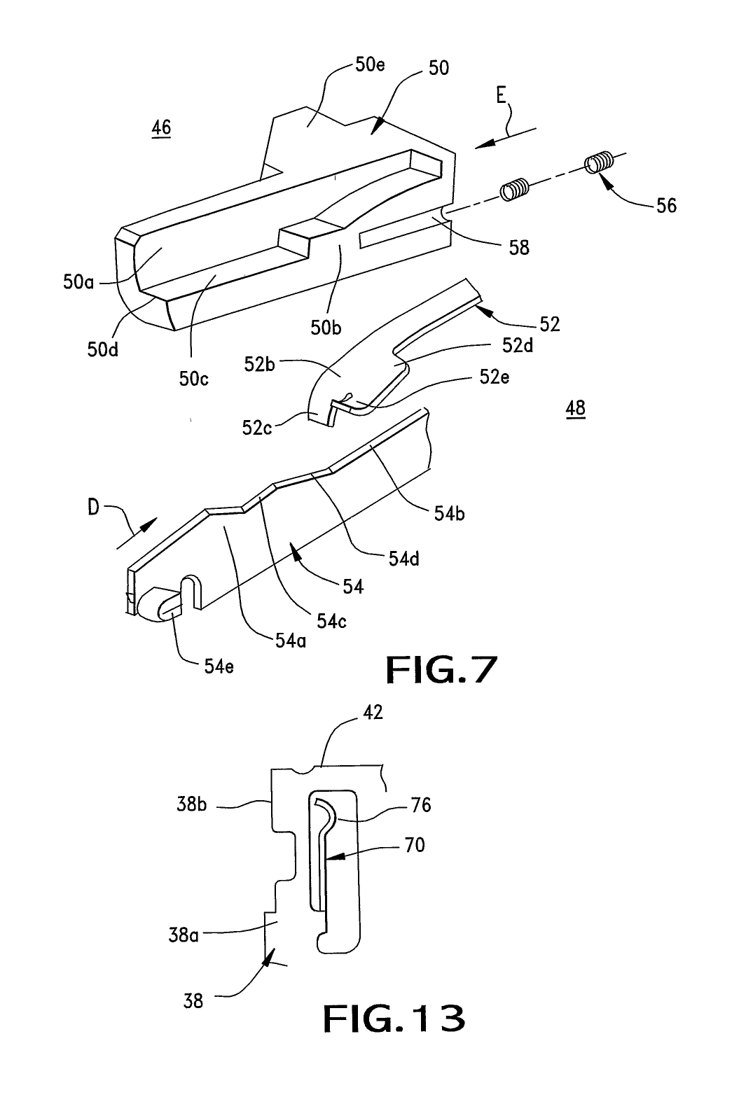

A card eject mechanism, generally designated 46, and a slider control mechanism, generally designated 48, are mounted along side wall section 36b of housing 36 and side wall 38b of metal shell 38. FIG. 7 shows various components of card eject mechanism 46 and slider control mechanism 48 in their general positional orientation within the connector. Specifically, the card eject mechanism includes a slider, generally designated 50, and the slider control mechanism includes a slide lock member, generally designated 52, and an ejection control member, generally designated 54. A coil spring, generally designated 56, is positioned partially into a bore 58 in the rear end of slider 50 to constantly bias the slider forwardly in the withdrawal direction indicated by arrow “E”.

Slider 50 is a one-piece structure unitarily molded of dielectric material such as plastic or the like, similar to insulative housing 36. The slider has a central, partition wall 50a which runs front-to-rear of the slider. A downwardly sloped step 50b is formed along the outside of partition wall 50a and leads to an upwardly sloped surface 50c that leads to a lock shoulder 50d at the front of the slider. The lock shoulder is generally perpendicular to the direction of sliding movement of the slider.

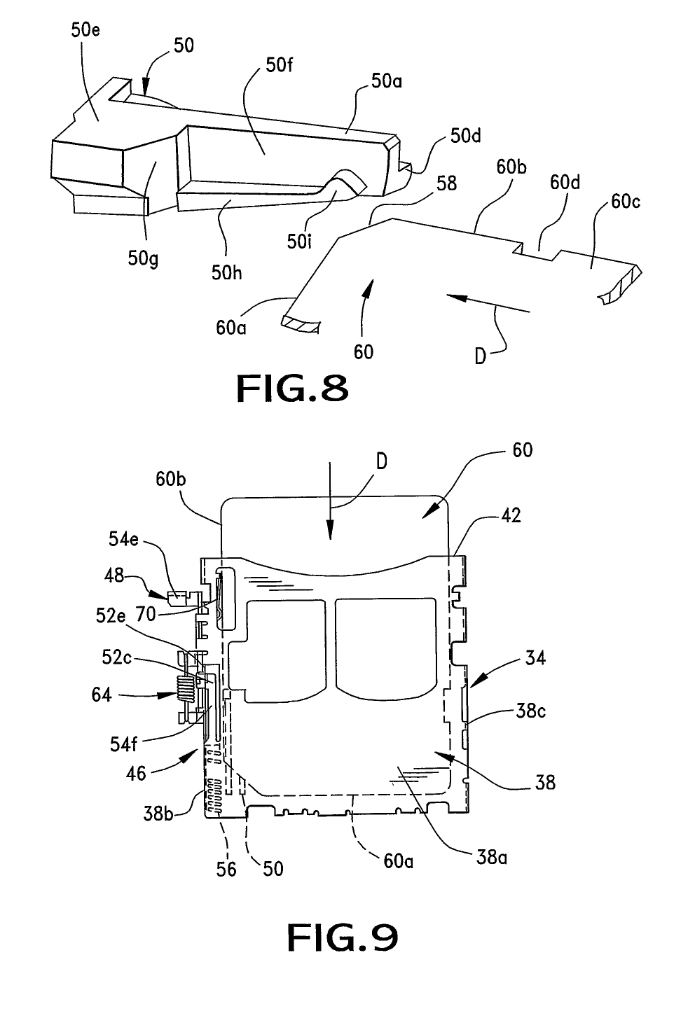

As best seen in FIG. 8, a lateral enlargement 50e projects inwardly from an inner surface 50f of partition 50a of slider 50. The lateral enlargement has a chamfered corner 37 for abutting a polarizing corner 58 (FIG. 8) of a memory card, generally designated 60 and described hereinafter. A flexible, cantilevered engagement arm 50h projects forwardly of lateral enlargement 50e and is spaced from inner surface 50f of partition wall 50a. The engagement arm has an upwardly projecting hook 50i at the distal end thereof.

Still referring to FIG. 8, memory card 60 has a leading end or edge 60a, a side edge 60b, a top surface 60c and an engagement recess 60d in the side edge. When the memory card is inserted into the cavity of connector 34, hook 50i at the distal end of engagement arm 50h of slider 50 “snaps” into recess 60d at the side edge of the memory card, automatically as polarizing corner 58 of the memory card engages chamfered corner 50g of the slider. The slider and the memory card then move into and out of the connector as a unitary assembly.

Referring back to FIG. 7, slide lock member 52 includes a cantilevered spring arm 52a, which is stamped and formed out of top wall 38a of metal shell 38. The distal end of the cantilevered spring arm is curved downwardly, as at 52b, and terminates in a lock portion or hook 52c. A lateral or offset portion 52d of the spring arm forms an upwardly curved hook 52e. Lock hook 52c engages lock shoulder 50d of slider 50. This occurs automatically as the slider and the memory card are moved to their fully inserted connection position.

Ejection control member 54 is stamped and formed of metal material and is located outside longitudinal side wall 38b of metal shell 38. The ejection control member has a step-like ridge formed on its upper edge 54a to define a bottom flat section 54b, a top flat section 54c and a sloped section 54d extending between the bottom and top flat sections. A manually engageable thumb portion 54e is formed at one end of the ejection control member, and a spring attachment portion 54f (FIG. 1) is formed at the opposite end of the ejection control member.

As best seen in FIG. 1, a coil spring 64 is attached between spring attachment portion 54f of the ejection control member and a spring engagement flange 66 which is stamped and formed out of side wall 38b of metal shell 38 to project outwardly therefrom. As best seen in FIG. 2, ejection control member 54 is slidably mounted to longitudinal side wall 38b of the metal shell by mounting flanges 68 which also are stamped and formed/raised from side wall 38b of the metal shell. When the ejection control member moves rearwardly in the card-insertion direction, coil spring 64 is stretched. When the pushing force is removed, the coil spring returns the ejection control member back to its initial stress-free position shown in FIG. 2.

Details of the operation of card eject mechanism 46 and slider control mechanism 48 can be derived from co-pending application Serial No. ______ (Docket No. A4-206) which was filed contemporaneously herewith and which is incorporated herein by reference. Suffice it to say that when no memory card is inserted into connector 34, slider 50 of card eject mechanism 46 is biased forwardly by coil spring 56 to an ejection or withdrawal position. Ejection control member 54 is biased by coil spring 64 to an inoperative position shown in FIG. 1. Lock hook 52c of slide lock member 52 engages surface 50c of slider 50 while upwardly curved hook 52e of the slide lock member confronts sloped edge Section 34d of ejection control member 54. When memory card 60 is pushed inwardly in the direction of arrow “D” to its fully inserted connection position shown in FIG. 9, hook 50i (FIG. 8) on engagement arm 50h of slider 50 snaps into recess 60b of the memory card and the card and slider move together into the connector to the inserted position of FIG. 9, compressing coil spring 56 of the card eject mechanism. As the slider moves rearwardly, lock hook 50c of slide lock member 52 snaps into locking engagement with lock shoulder 50d of the slider, whereby the slider and the memory card are locked and held in the inserted position of FIG. 9. In this position, coil spring 64 of the slider control mechanism is stretched.

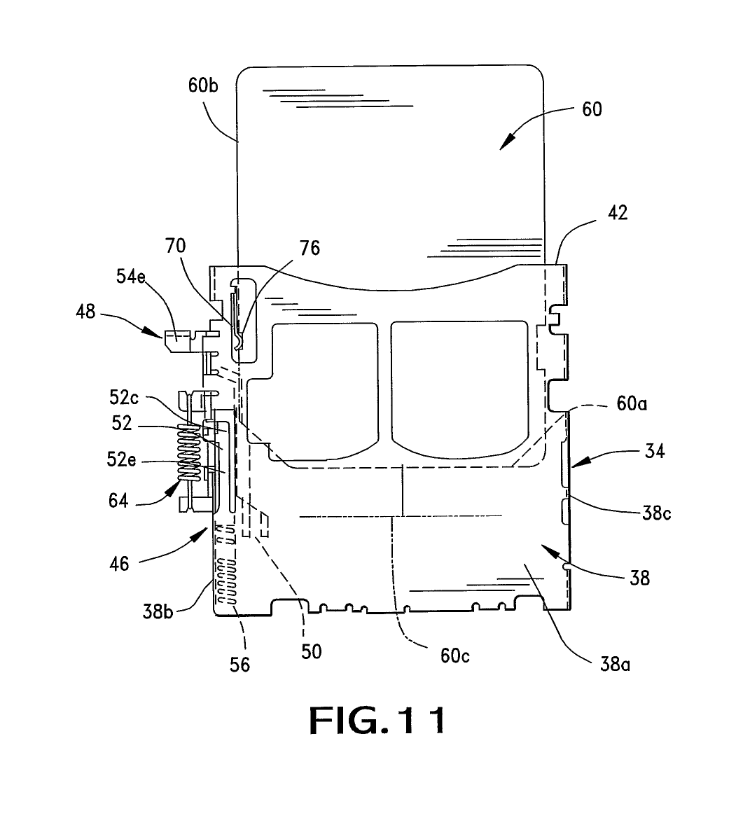

Before proceeding with an explanation of the ejection process of memory card 60, reference is made back to FIGS. 5 and 6 which show a catch means, generally designated 70, for preventing over-running of the memory card when it is moved in an ejection direction as indicated by arrow “E” in FIG. 1. In other words, as stated in the Background, above, it would be desirable to stop the memory card at a withdrawal position (see FIG. 11) so that the card does not move forwardly and fall out of the connector under the influence of inertia caused by spring 56 of card eject mechanism 46 or any other ejection biasing means when slider 50 stops at its withdrawal position.

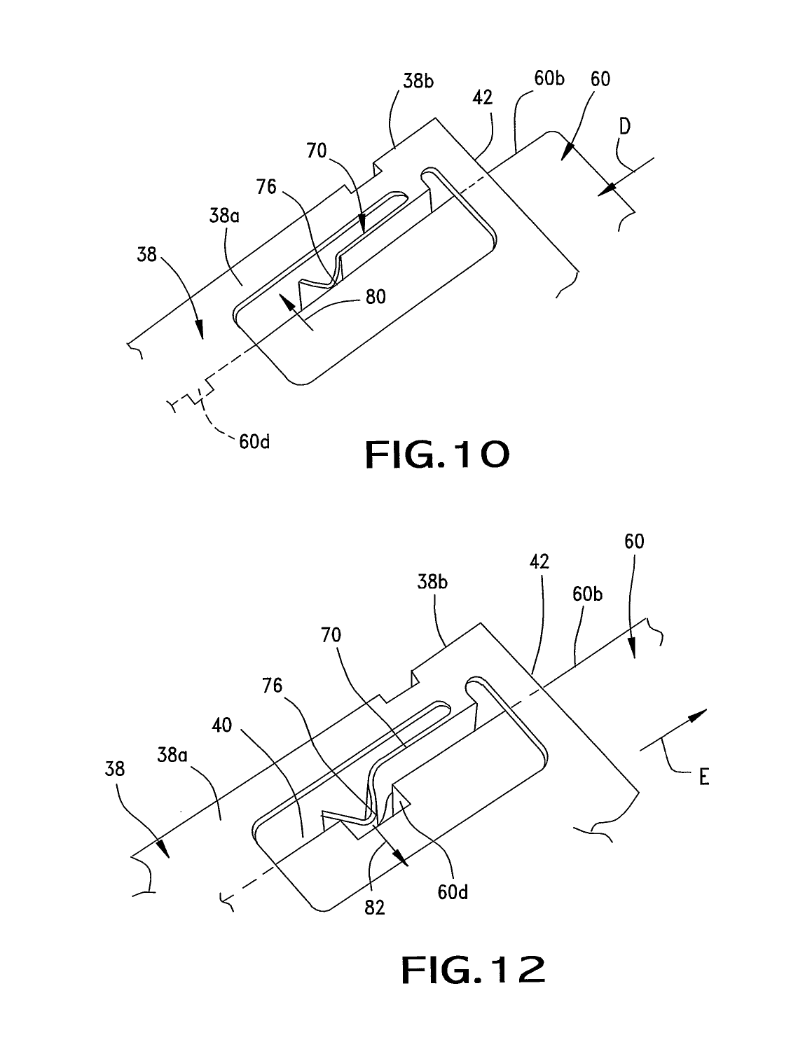

More particularly, catch means 70 provides an anti-over-running mechanism in the form of a cantilevered leaf spring, which is stamped and formed out of top wall 38a of metal shell 38. The leaf spring is connected to the top wall of the metal shell at a base 72 and is bent downwardly so that the leaf spring generally lies in a plane perpendicular to the top wall of the shell. The leaf spring is cantilevered from base 72 to a free end 74. The free end of the leaf spring is formed with an inwardly directed V-shaped hook 76. As seen in FIG. 10, leaf spring 70 is near the front insertion opening 42 of cavity 40.

When memory card 60 is pushed into connector 34 in the direction of arrow “D” as shown in FIG. 10, recess 60d (which engages the slider of the eject mechanism) rides over hook 76 while side edge 60b of memory card 60 pushes on the hook and biases leaf spring 70 outwardly in the direction of arrow 80. This “cocks” or stores energy in the leaf spring.

The eject mechanism is released and the memory card is ejected by pushing on the manually engageable thumb portion 54e of ejection control member 54 in the insertion direction. Inward movement of the ejection control member causes the upwardly curved hook 50d of slide lock member 52 to ride upwardly along sloped edge section 54d of ejection control member 54. This causes lock hook 52c of the slide lock member to move out of locking engagement with lock shoulder 50d of slider 50 as the upwardly curved hook 52a of the slide lock member moves onto the top flat section 54c of ejection control member 54 to maintain cantilevered spring arm 52a of the slide lock member in a raised condition. As a result, slider 50 is unlocked and the slider, along with memory card 60, are ejected under the influence of coil spring 56 of the card eject mechanism, i.e., biasing the card back to its final position.

When the eject mechanism is released and ejection spring 56 moves memory card 60 in the ejection direction indicated by arrow “E” in FIG. 12, recess 60d in side edge 60b of the memory card will confront hook 76 on leaf spring 70, and the cocked leaf spring will force the hook into the recess as shown in FIG. 12 to catch the memory card and prevent the memory card from moving further in the ejection direction. In essence, the interengagement of hook 76 within recess 60d stops the memory card so that the card does not move further in the ejection direction and fall out of the connector under the influence of the ejection spring or simply under the influence of inertia when slider 50 of the eject mechanism is stopped. FIG. 11 shows the full connector with memory card 60 in its position stopped by the catch means of the invention formed by leaf spring 70 and its hook 76. The double-headed arrow “F” in FIG. 11 indicates the distance that a memory card may travel from the point where it releases from slider 50 to the point where it catches on hook 76 of leaf spring 70. This distance can vary depending on the location of hook 76, as will be seen below.

FIG. 13 shows an alternative embodiment of the invention wherein the catch means provided by leaf spring 70 and hook 76 again are stamped and formed out of top wall 38a of metal shell 38. However, in this embodiment, the leaf spring is directed forwardly in the ejection direction rather than rearwardly in the insertion direction as shown in the first embodiment of FIGS. 5, 6, 10 and 12. This brings hook 76 closer to the front insertion opening 42 of the connector. The positioning of hook 76 should take in consideration how the inertia of the memory card in its insertion movement is decreased by friction between the card and the surrounding components of the connector, such as the metal shell and the insulative housing, so that it is assured that recess 60d of the memory card will not bypass the V-shaped hook 76 of the leaf spring without being caught. Still another alternative embodiment (not shown) would be to stamp and form leaf spring 70 so that the leaf spring remains in the plane of top wall 38a of the metal shell and hook 76 is directed downwardly or inwardly into cavity 40. In this embodiment, the hook would confront surface 60c FIG. 8) of the memory card instead of confronting the longitudinal side edge 60b of the card.

Finally, it should be understood that the card anti-over-running catch means of the invention is equally applicable for use with other card eject mechanisms than that shown herein. For instance, the catch means could be used quite advantageously with a push/push mechanism wherein a “heart”-shaped cam slot is provided in the slide member of the eject mechanism and operatively associated with a cam pin, as it known in the art. The catch means of the invention again would prevent the eject spring of the push/push eject mechanism from pushing the memory card out of the connector or the memory card from falling from the connector under its own inertia.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector (34), comprising:
an insulative housing (36) having a terminal-mounting section (36a) which mounts a plurality of conductive terminals (44) having contact portions (44a) for engaging appropriate contacts on a memory card (60) and which at least in part defines a card-receiving cavity (40) for receiving the memory card;
a card eject mechanism (46) including a slider (50) movably mounted on the housing and engageable with the memory card for movement therewith into and out of the cavity between an inserted connection position and a withdrawal position, and an ejection spring (56) to bias the slider and memory card in an ejection direction toward said withdrawal position; and
a catch means (70) for catching the memory card in its movement in said ejection direction and preventing the memory card from moving under inertia beyond said withdrawal position.

2. The memory card connector of claim 1 wherein said cavity (40) has a front insertion opening (42), and the catch means (70) is located near the opening.

3. The memory card connector of claim 1 wherein said catch means comprise a catch member (70) on the connector engageable with a recess (60d) in the memory card (60).

4. The memory card connector of claim 3 wherein catch member comprises a cantilevered leaf spring (70).

5. The memory card connector of claim 1 wherein said terminal-mounting section (36a) of the housing (36) is a rear section and including at least one side wall section (36b) of the housing extending forwardly from one end of the rear section, said card eject mechanism (46) and said catch means (70) being on said side wall section.

6. The memory card connector of claim 5 wherein catch member comprises a cantilevered leaf spring (70).

7. The memory card connector of claim 1, including a metal shell (38) mounted on the housing (36) and combining therewith to define said cavity (40) having a front insertion opening (42) to permit insertion and withdrawal of the memory card (60) into and out of the connector, said catch means being on the metal shell.

8. The memory card connector of claim 7 wherein said catch means (70) is located near the front insertion opening (42) of the cavity (40).

9. The memory card connector of claim 8 wherein said catch means (70) is integral with the metal shell (38).

10. The memory card connector of claim 9 wherein said shell (38) is stamped and formed from sheet metal material and the catch means (70) is stamped and formed therefrom.

11. The memory card connector of claim 10 wherein said catch means comprise a catch member (70) integral with the metal shell (38) engageable with a recess (60d) in the memory card (60).

12. The memory card connector of claim 11 wherein catch member comprises a cantilevered leaf spring (70).

13. The memory card connector of claim 10 wherein said metal shell (38) includes a top wall (38a) and at least one side wall (38b), and the catch means (70) is stamped and formed from the top wall of the shell.

14. The memory card connector of claim 13 wherein said catch means comprises a cantilevered spring (70).

15. A memory card connector (34), comprising:
an insulative housing (36) having a terminal-mounting section (36a) and at least one side wall section (36b) extending forwardly from one end of the rear section which mounts a plurality of terminals (44) having contact portions (44a) for engaging appropriate contacts on a memory card (60);
a metal shell (38) mounted on the housing and combining therewith to define a card-receiving cavity (40) having a front insertion opening (42) to permit insertion and withdrawal of the memory card into and out of the connector between an inserted connection position and a withdrawal position;
a card eject mechanism (46) including a slider (50) movably mounted on the side wall section of the housing and engageable with the memory card for movement therewith, and an ejection spring (56) to bias the slider and memory card in an ejection direction toward said withdrawal position; and
a catch means (70) integral with the metal shell (38) for catching the memory card in its movement in said ejection direction and preventing the memory card from moving under inertia beyond said withdrawal position.

16. The memory card connector of claim 15 wherein said catch means (70) is located near the front insertion opening (42) of the cavity (40).

17. The memory card connector of claim 15 wherein said catch means is integral with the metal shell.

18. The memory card connector of claim 17 wherein said shell (38) is stamped and formed from sheet metal material and the catch means (70) is stamped and formed therefrom.

19. The memory card connector of claim 18 wherein said catch means comprise a catch member (70) integral with the metal shell (38) engageable with a recess (60d) in the memory card (60).

20. The memory card connector of claim 19 wherein catch member comprises a cantilevered leaf spring (70).

21. The memory card connector of claim 18 wherein said metal shell (38) includes a top wall (38a) and at least one side wall (38b), and the catch means (70) is stamped and formed from the top wall of the shell.

22. The memory card connector of claim 21 wherein said catch means comprises a cantilevered spring (70).

23. A memory card connector (34), comprising:
an insulative housing (36) having a terminal-mounting section (36a) which mounts a plurality of conductive terminals (44) having contact portions (44a) for engaging appropriate contacts on a memory card (60) and which at least in part defines a card-receiving cavity (40) for receiving the memory card;
a card eject member (50) movably mounted on the housing and engageable with the memory card for movement therewith into and out of the cavity between an inserted connection position and a withdrawal position, and an ejection spring (56) to bias the card eject member and memory card in an ejection direction toward said withdrawal position; and
a catch means (70) for catching the memory card in its movement in said ejection direction and preventing the memory card from moving under inertia beyond said withdrawal position.

24. The memory card connector of claim 23 wherein said catch means comprise a catch member (70) on the connector engageable with a recess (60d) in the memory card (60).

25. The memory card connector of claim 24 wherein catch member comprises a cantilevered leaf spring (70).

26. The memory card connector of claim 23, including a metal shell (38) mounted on the housing (36) and combining therewith to define said cavity (40) having a front insertion opening (42) to permit insertion and withdrawal of the memory card (60) into and out of the connector, said catch means being on the metal shell.

27. The memory card connector of claim 26 wherein said shell (38) is stamped and formed from sheet metal material and the catch means (70) is stamped and formed therefrom.

28. The memory card connector of claim 27 wherein said metal shell (38) includes a top wall (38a) and at least one side wall (38b), and the catch means (70) is stamped and formed from the top wall of the shell.
